(19) United States
(12) Patent Application Publication
(10) Pub. No.: US 2015/0138444 A1
(43) Pub. Date: May 21, 2015

(54) VIDEO DISPLAY APPARATUS AND TERMINAL DEVICE

(71) Applicants: Masayuki Hirabayashi, Tokyo (JP); Hideo Nishijima, Ibaraki (JP); Nobuo Masuoka, Ibaraki (JP)

(72) Inventors: Masayuki Hirabayashi, Tokyo (JP); Hideo Nishijima, Ibaraki (JP); Nobuo Masuoka, Ibaraki (JP)

(21) Appl. No.: 14/406,546

(22) PCT Filed: Sep. 14, 2012
(86) PCT No.: PCT/JP2012/073567

§ 371 Date: Dec. 9, 2014

(51) Int. Cl. H04N 5/44

(52) U.S. Cl. CPC H04N 5/4403; H04N 2005/4442
USPC 348/734

(57) ABSTRACT

The present invention provides a video display apparatus and a terminal device that are easy to use. The present invention is provided with a display unit for displaying video content, a receiving unit for receiving a command transmitted by the terminal device, and a control unit for executing a process corresponding to the command received from the receiving unit. The control unit executes a process corresponding to a first command when the first command is received from a specific terminal device, but not a process corresponding to the first command when the first command is received from another terminal device; and executes a process corresponding to a second command when the second command is received from the specific terminal device or the other terminal device.

### TECHNICAL FILED

The present invention relates to a video display apparatus and a terminal device.

### BACKGROUND ART

One of background art in this technical field is described in Japanese Patent Application Laid-Open No. 2002-51232 (PTL 1). In this publication, the problem is described as “to enable optimum operation settings between a plurality of apparatuses to be controlled to be performed easily.”

As a solution of this problem, the publication describes, “a receiving apparatus is configured to include a receiving unit which receives a television signal, a processing unit which processes the television signal received by the receiving unit to obtain an image signal, a display unit which displays an image according to the image signal obtained by the processing unit, a transceiver unit which receives information transmitted from a remote control apparatus and transmits information to the remote control apparatus, and a control unit which transmits to the remote control apparatus setting information related to an operation setting status of the apparatus by the transceiver unit in accordance with a power off command transmitted from the remote control apparatus and carries out a power-off process.”

### CITATION LIST

### Patent Literature

PTL 1: Japanese Patent Application Laid-Open No. 2002-51232

### SUMMARY OF INVENTION

### Technical Problem

PTL 1 describes as an effect of the invention, “it is possible to easily perform a given operation setting between apparatuses.” Thus, in a case where a single user uses a plurality of video display apparatuses, excellent usability is provided. However, a case where a plurality of users use a single video display apparatus or a plurality of users use a plurality of video display apparatuses is not considered.

For example, there is a problem that, when a plurality of users simultaneously instruct a single video display apparatus (receiving apparatus) to change a channel with terminal devices (remote control devices), a display screen of the video display apparatus changes rapidly and viewing becomes difficult.

It is therefore an object of the present invention to provide a video display apparatus and a terminal device which are excellent in usability.

### Solution to Problem

To solve the above problem, structures recited in the claims are adopted, for example. The present application contains a plurality of solutions for the above-described problem, and one example of them includes a display unit which displays a video content, a receiving unit which receives a command transmitted from a terminal device, and a control unit which executes processing in accordance with the command received by the receiving unit. The control unit executes processing in accordance with a first command when the first command from a specific terminal device is received, while it does not execute the processing in accordance with the first command when the first command from another terminal device is received. When a second command from the other terminal device is received, the control unit executes processing in accordance with the second command.

### Advantageous Effects of Invention

According to the present invention, a video display apparatus and a terminal device which are excellent in usability can be provided.

Other problems, structures, and effects than those described above will be apparent by the following description of embodiments.

### BRIEF DESCRIPTION OF DRAWINGS

FIG. 1 is a diagram showing the configuration of a video display system according to a first embodiment.

FIG. 2 is a block diagram showing the configuration of a terminal device according to the first embodiment.

FIG. 3 is a block diagram showing the configuration of a video display apparatus according to the first embodiment.

FIG. 4 is a flowchart of an operation of the terminal device in the first embodiment.

FIG. 5A shows an exemplary display on a screen of the terminal device in the first embodiment.

FIG. 5B shows an exemplary display on the screen of the terminal device in the first embodiment.

FIG. 5C shows an exemplary display on the screen of the terminal device in the first embodiment.

FIG. 5D shows an exemplary display on the screen of the terminal device in the first embodiment.

FIG. 6 is a flowchart of an operation of the video display apparatus in the first embodiment.

FIG. 7 is a flowchart of an operation of a video display apparatus in a second embodiment.

FIG. 8 is a flowchart of an operation of a video display apparatus in a third embodiment.

FIG. 9 is a flowchart of an operation of a video display apparatus in a fourth embodiment.

FIG. 10A shows exemplary priorities of terminal devices in the fourth embodiment.

FIG. 10B shows exemplary priorities of terminal devices in the fourth embodiment.

FIG. 11 is a flowchart of an operation of a video display apparatus in a fifth embodiment.

FIG. 12A shows an exemplary display on a screen of a terminal device in the fifth embodiment.

FIG. 12B shows an exemplary display on the screen of the terminal device in the fifth embodiment.

FIG. 13 is a flowchart of an operation of a terminal device in a sixth embodiment.

FIG. 14 is a flowchart of an operation of a video display apparatus in the sixth embodiment.

### DESCRIPTION OF EMBODIMENTS

Embodiments are described below, referring to the drawings.

### Example 1

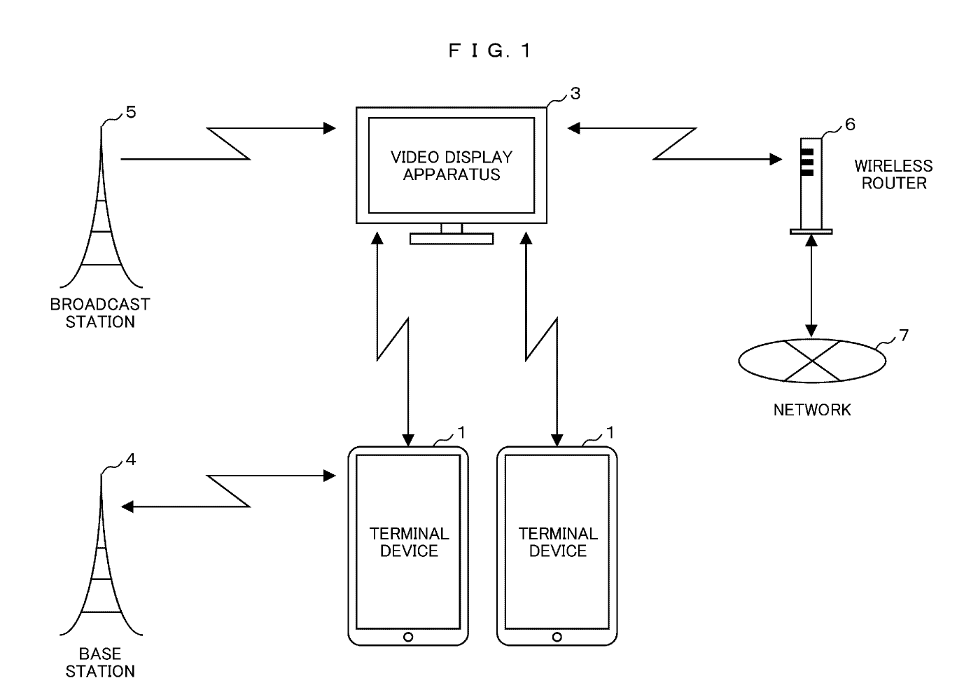

FIG. 1 shows a video display system of a first embodiment of the present invention. The video display system of this embodiment includes a plurality of terminal devices 1 and a video display apparatus 3.

The terminal device 1 has a wireless communication function and can transmit/receive various types of information to/from a base station 4. Moreover, the terminal device 1 has a function of performing a control of the video display apparatus 3 at a remote location (hereinafter, referred to as a “remote control”), so that a user can operate a channel, a volume and the like of the video display apparatus 3 with the terminal device 1.

The video display apparatus 3 is an apparatus for receiving and displaying a video content and, for example, can receive a television signal from a broadcast station 5 wirelessly or by wire and can display a video content based on that television signal. Moreover, the video display apparatus 3 can display a video content such as an Internet content received from a network 7 via a wireless router 6. Please note that the video display apparatus 3 is not limited to one, but a plurality of video display apparatuses may exist.

A base station 4 is an apparatus for relaying between a telephone network and the terminal device 1 and can transmit/receive various types of information to/from the terminal device 1. For example, the base station 4 can transmit TV listings for viewing of the video display apparatus 3 to the terminal device 1.

The broadcast station 5 is an apparatus which outputs a television signal.

The wireless router 6 has a function of a wireless LAN (Local Area Network) such as Wi-Fi (Wireless Fidelity), and can connect with the network 7 via a communication line. The video display apparatus 3 can obtain a video content and various types of information from the Internet by connecting with the wireless router 6. The terminal device 1 may be also provided with a wireless LAN function to obtain various types of information from the Internet. Moreover, although an example is shown in which the wireless router 6 and the video display apparatus 3 are wirelessly connected to each other, they may be connected by wire.

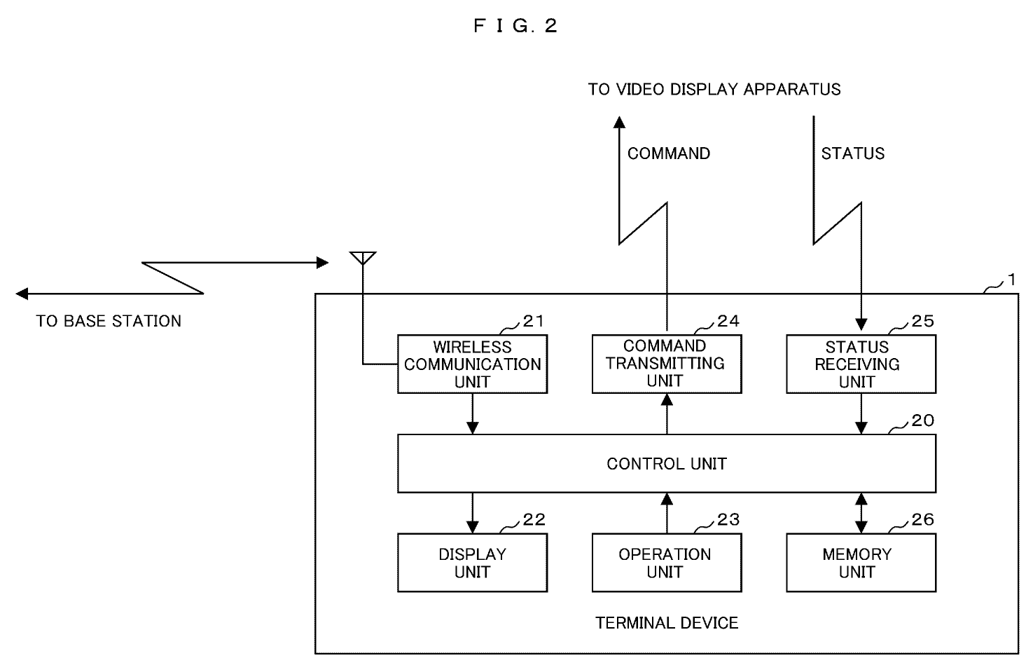

FIG. 2 is a block diagram showing the configuration of the terminal device 1 of FIG. 1.

A control unit 20 controls respective units of the terminal device 1. The control unit 20 is configured by a CPU (Central Processing Unit), a given control circuit, or a dedicated circuit such as ASIC.

A wireless communication unit 21 of the terminal device 1 is configured by an antenna, a communication circuit including a coding circuit and a decoding circuit, and the like, and communicates with the base station 4 to transmit/receive various types of information thereto/therefrom.

A display unit 22 is a liquid crystal panel, for example, and displays various types of information. An operation unit 23 is a touch pad, for example, and receives an operation by a user and transmits an instruction based on that operation to the control unit 20. A unit obtained by combining and integrating the liquid panel and the touch pad with each other is generally called as a touch panel. In this embodiment, an example of using the touch panel is described.

A command transmitting unit 24 transmits a control command to the video display apparatus 3 via infrared light, Wi-Fi, Wi-Fi Direct, or Bluetooth (registered trademark), for example. A status receiving unit 25 receives status information from the video display apparatus 3 by using Wi-Fi or the like similarly. The control command is information for performing a remote control of the video display apparatus 3 by the terminal device 1 and, for example, contains a power command instructing the video display apparatus 3 to turn a power on/off and a setting command which specifies a specific channel or a volume. The status information is information specifying whether or not the remote control is possible, and contains the presence or absence of an authority for performing the remote control, priorities of a plurality of terminal devices 1, and the like. Please note that transmission of the control command to the video display apparatus 3 and receiving of the status information from the video display apparatus 3 may be carried out indirectly via the wireless router 6 or the like. Moreover, the command transmitting unit 24 and the status receiving unit 25 may be separate units or be configured integrally by one unit of hardware.

When transmitting the control command, the command transmitting unit 24 also transmits an identification code unique to the terminal device 1. To the identification code, an ID individually assigned to the terminal device 1, a phone number, or the like is applicable. Moreover, since it is generally assumed that one user owns one terminal device 1, a user ID, which is given to each user by a manufacturer of the terminal device 1 or the like, can be applied to the identification code. In this case, the user ID is stored in advance in the terminal device 1 based on an operation by the user or the like.

A memory unit 26 is configured by a ROM (Read Only Memory), a RAM (Random Access Memory), a flash ROM or the like, to store a program for controlling the terminal device 1 and various types of set values.

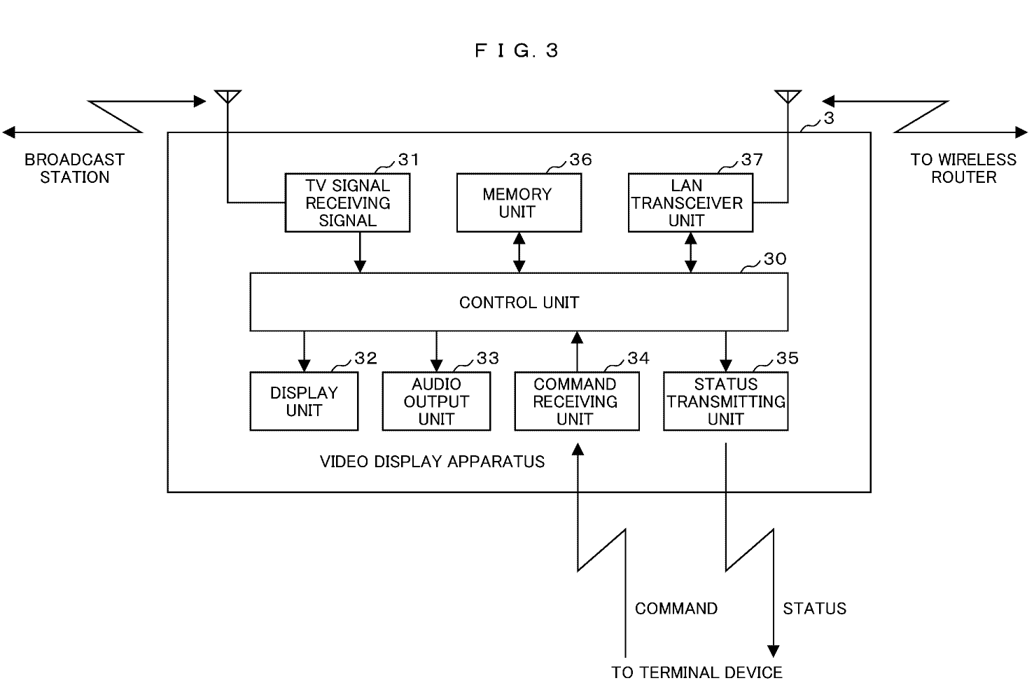

FIG. 3 is a block diagram showing the configuration of the video display apparatus 3 of FIG. 1.

A control unit 30 controls respective units of the video display apparatus 3. The control unit 30 is configured by a CPU, a given control circuit, or a dedicated circuit such as ASIC.

A TV signal receiving signal 31 is configured by a communication circuit including a decoding circuit, and the like, and receives a television signal output from the broadcast station 5, decodes a video and an audio, and sends them to a display unit 32 and an audio output unit 33.

The display unit 32 is configured by a liquid crystal panel, a plasma panel, an organic EL (Electro Luminescence) panel, or the like, and displays various types of video contents and various types of information. The audio output unit 33 is configured by an amplifier and a speaker, for example, and outputs various types of audios.

A command receiving unit 34 receives the control command and the identification code from the terminal device 1 by using infrared light, Wi-Fi, Wi-Fi Direct, or Bluetooth, for example, and sends the instruction from the terminal device 1 to the control unit 30. A status transmitting unit 35 transmits status information to the terminal device 1. The command receiving unit 34 and the status transmitting unit 35 may be separate units or one integrated unit.

A memory unit 36 is configured by a ROM, a RAM, or a flash ROM, for example, and stores a program for controlling the video display apparatus 3, various types of setting information, the identification code of the terminal device 1 which has transmitted a power command, the priorities of the respective terminal devices 1, and the like. The memory unit 36 may include a storage such as a HDD (Hard Disk Drive) or a BD (Blu-ray Disc) drive to store a video content.

A LAN transceiver unit 37 connects with the wireless router 6 by wire or wirelessly and can receive a video content from the Internet or the like.

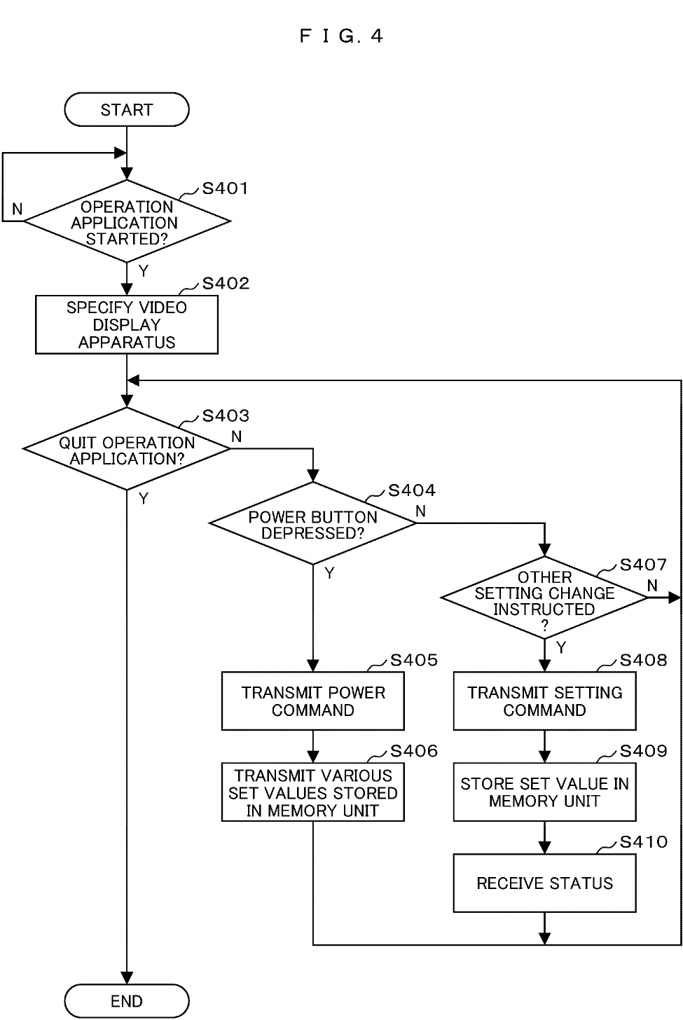

FIG. 4 is a flowchart of an operation of the terminal device 1 when performing the remote control of the video display apparatus 3.

In the following description, when a terminal device 1 and another terminal device 1 have to be distinguished from each other, one of them is denoted by 1a and the other is denoted by 1b in some cases.

In Step S401, the terminal device 1 waits for a start of application software for performing the remote control of the video display apparatus 3 (hereinafter, referred to as an “operation application”) based on an operation by a user.

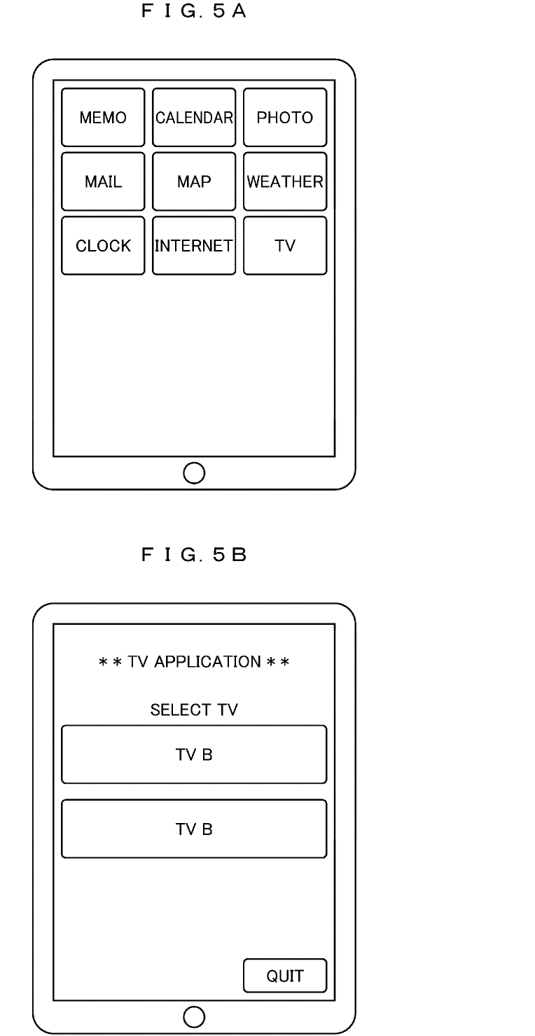

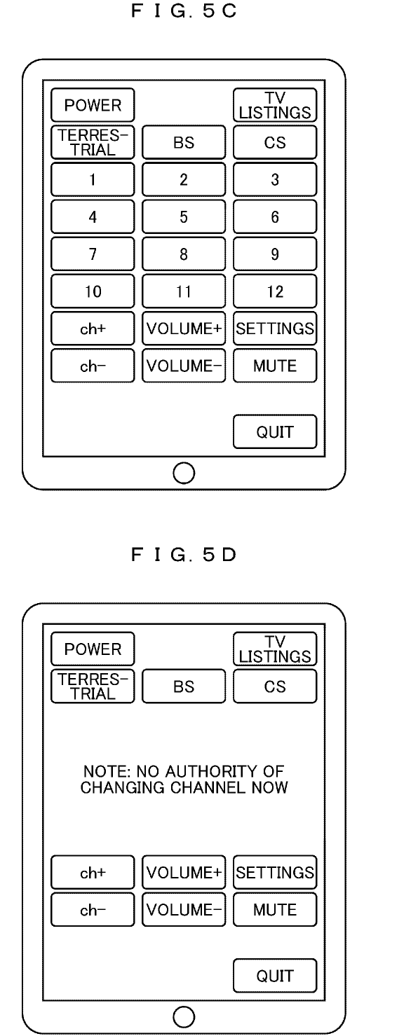

FIGS. 5A to 5D show various types of exemplary displays of the touch panel type display unit 22 of the terminal device 1. FIG. 5A shows a menu screen in which various types of application software are arranged on the terminal device 1. The operation application starts when a “TV” button displayed in the touch panel is depressed by a user.

In Step S402, the terminal device 1 selects a video display apparatus 3 as a target of the remote control based on the user's operation. FIG. 5B shows an exemplary display on a selection screen in a case where there are two video display apparatuses 3 which can be selected as a control target of the remote control. It is assumed here that “TV A” is selected.

When having selected the video display apparatus 3 as the control target of the remote control, the terminal device 1 displays various types of instructions which can be transmitted to the video display apparatus 3. FIG. 5C shows an exemplary display on an operation screen of the video display apparatus 3 at that time.

Then, in Step S403, the terminal device 1 confirms whether or not the user has performed an operation for quitting the operation application. In a case where the user has performed the operation for quitting the operation application, the terminal device 1 returns to a process for displaying the menu screen.

In Step S404, the terminal device 1 confirms whether or not the user has depressed a power button. In a case where the user has depressed the power button displayed on the terminal device 1, the terminal device 1 transmits the power command to the video display apparatus 3 (Step S405), transmits various types of set values such as a channel or a volume, stored in the memory unit 26 of the terminal device 1 to the video display apparatus 3, as a setting command in Step S406, and repeats Step S403 and the subsequent steps.

The terminal device 1 transmits the identification code of the terminal device 1 when transmitting the power command or the setting command.

The terminal device 1 transmits the setting command including the channel or the various types of set values stored in the memory unit 26 to the video display apparatus 3 after transmitting the power command, thereby being able to set the video display apparatus 3 as set in the terminal device 1.

In a case where the user has not depressed the power button displayed on the terminal device 1, the terminal device 1 confirms whether or not the user has directed a setting change other than turning a power on/off in Step S407. The setting change other than the turning power on/off is, for example, switching a channel or a volume, or adjusting an image quality.

In a case where the user has directed the change of the setting of the video display apparatus 3, the terminal device 1 transmits the corresponding setting command to the video display apparatus 3 (Step S408), and stores a set value in the memory unit 26 of the terminal device 1 in Step S409.

For example, in a case where a channel 1 button has been depressed, a setting command instructing the video display apparatus 3 to switch over a channel 1 is transmitted to the video display apparatus 3 and the channel 1 is stored in the memory unit 26. In a case where a channel+button is then depressed, a setting command incrementing the channel or a setting command instructing the video display apparatus 3 to switch over to a channel 2 is transmitted to the video display apparatus 3 and the channel 2 is stored in the memory unit 26. In this manner, in a case where the setting command specifies a relative value such as a channel+ or a channel−, the relative value is replaced with an absolute value such as a channel 2 and only a final value is stored in the memory unit 26.

Then, the terminal device 1 receives status information transmitted from the video display apparatus 3 in Step S410, displays information to be displayed which corresponds to the status information, if it exists, on the display unit 22 of the terminal device 1, and repeats Step S403 and the subsequent steps. When the setting command is transmitted, the identification code of the terminal device 1 is also transmitted. FIG. 5D shows an exemplary display of the status information.

In a case where the user has not given the instruction of changing the setting of the video display apparatus 3 in Step S407, the terminal device 1 repeats Step S403 and the subsequent steps.

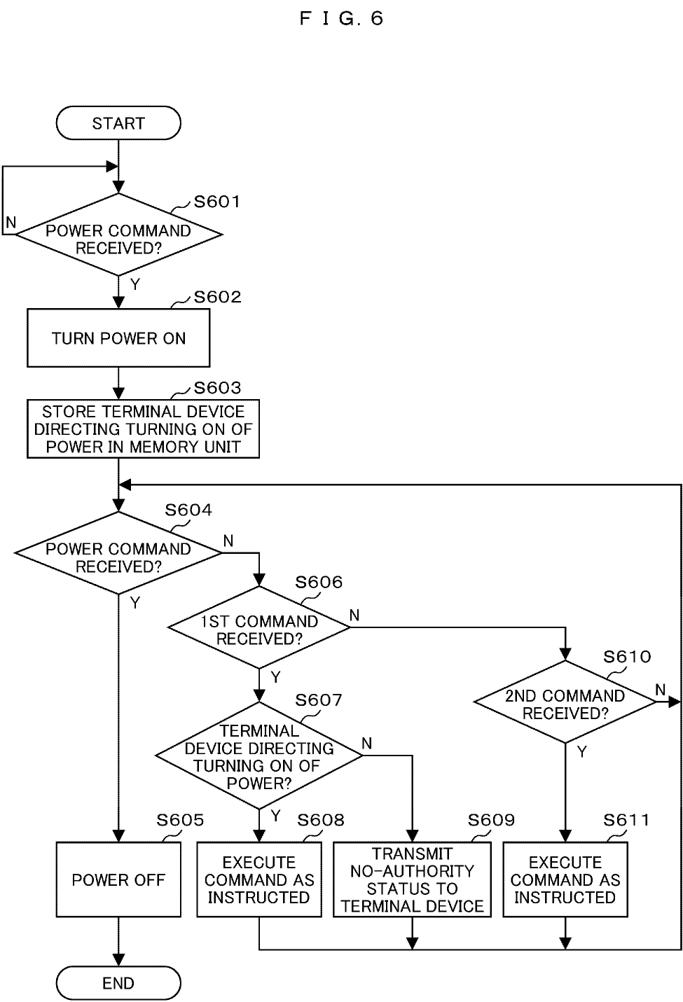

FIG. 6 is a flowchart of an operation of the video display apparatus 3 of the first embodiment.

In Step S601, the video display apparatus 3 waits for receiving of the power command. When having received the power command, the video display apparatus 3 turns a power on (Step S602) and reflects various types of set values transmitted from the terminal device 1 thereto. Then, in Step S603, the video display apparatus 3 stores information indicating which terminal device 1 has transmitted the power command, i.e., the identification code transmitted together with the power command, in the memory unit 36. It is assumed here that the terminal device 1a has transmitted the power command.

Next, in Step S604, the video display apparatus 3 confirms whether or not it has received the power command again. In a case where having received the power command, the video display apparatus 3 turns the power off (Step S605). In a case where the video display apparatus 3 has not received the power command, the video display apparatus 3 confirms whether or not it has received a first command in Step S606. The first command is a setting command instructing the video display apparatus 3 to change a channel or change an input, for example. When having received the first command, the video display apparatus 3 confirms whether or not the first command is a setting command from a specific terminal device 1, i.e., the terminal device 1 which has instructed the video display apparatus 3 to turn the power on (Step S607). In a case where the first command is the setting command from the terminal device 1 instructing the video display apparatus 3 to turn the power on, the video display apparatus 3 executes the command as instructed (Step S608), and repeats Step S604 and the subsequent steps.

In Step S607, in a case where the first command is not the setting command from the terminal device 1 instructing turning power on, the video display apparatus 3 transmits to the corresponding terminal device 1 status information indicating no authority of changing a channel or the like (Step S609) and thereafter repeats Step S604 and the subsequent steps. For example, when receiving the first command from the terminal device 1b, the video display apparatus 3 transmits status information indicating that processing based on this command is not possible to the terminal device 1b, and the terminal device 1b displays an indication that the terminal device 1b has no authority of executing that command on the display unit 22. FIG. 5D shows an exemplary indication of no authority of changing a channel.

In Step S606, in a case where the first command has not been received, the video display apparatus 3 confirms whether or not it has received a second command (Step S610). The second command is a setting command other than the first command, and more specifically is a setting command to specify a volume, adjust an image quality, change a video mode, change an audio mode, adjust brightness, and adjust a contrast, for example.

The first command may be the setting command not only to select a channel and change an input, but also to specify a volume, adjust an image quality, change a video mode, change an audio mode, adjust brightness, and adjust a contrast, for example, while the second command may be a setting command to make a reservation of viewing or a reservation of recording.

Moreover, for improving convenience, the first command and the second command may be specified (changed) by the user.

In a case where having received the second command, the video display apparatus 3 executes the command as instructed (Step S611) and thereafter repeats Step S604 and the subsequent steps. In a case where the video display apparatus 3 has not received the second command in Step S610, the video display apparatus 3 repeats Step S604 and the subsequent steps.

In this manner, execution of the processing related to the first command by the video display apparatus 3 is possible only when having been instructed by the terminal device 1a turning the power of the video display apparatus 3 on. Execution of the processing related to the second command is possible both in a case where the terminal device 1a has instructed and in a case where the terminal device 1b has instructed.

It should be noted that an authority of turning the power of the video display apparatus 3 off may be given to only the terminal device 1 which has transmitted the instruction of turning the power on.

With this structure, in the first embodiment of the present invention, the terminal device 1 stores the settings such as the channel and the volume, transmitted to the video display apparatus 3, and transmits the power command and the set value stored therein to the video display apparatus 3. Thus, when the user only turns the video display apparatus 3 on via the terminal device 1, the video display apparatus 3 is set to the channel and the volume of previous viewing.

Since various types of set values are stored in each terminal device 1, each of a plurality of users can store a set value of the video display apparatus 3 in the terminal device 1 of that user, and can set the video display apparatus 3 to the setting in the previous viewing of that user when turning the video display apparatus 3 on by using the terminal device 1 of that user. Furthermore, it is possible to reflect the setting with which a certain video display apparatus 3 has been viewed onto another video display apparatus 3.

In addition, the authority of execution of the first command in the video display apparatus can be given to the terminal device 1a turning on that video display apparatus 3 only, while the authority of execution of the second command can be given to all the terminal devices 1a to 1b. In a case where the setting command to change a channel is applied to the first command, for example, only the terminal device 1a which has instructed the video display apparatus 3 to turn the power on can select a channel. Thus, it is possible to prevent viewing of a video content which is being performed by one user from being interfered by another user.

### Example 2

Next, a second embodiment of the present invention is described. The structure, effects and the like in the present embodiment are the same as those in the first embodiment unless otherwise specifically mentioned. Therefore, differences between the present embodiment and the first embodiment are mainly described in the following description, and the description of common points is minimized for avoiding duplicate description.

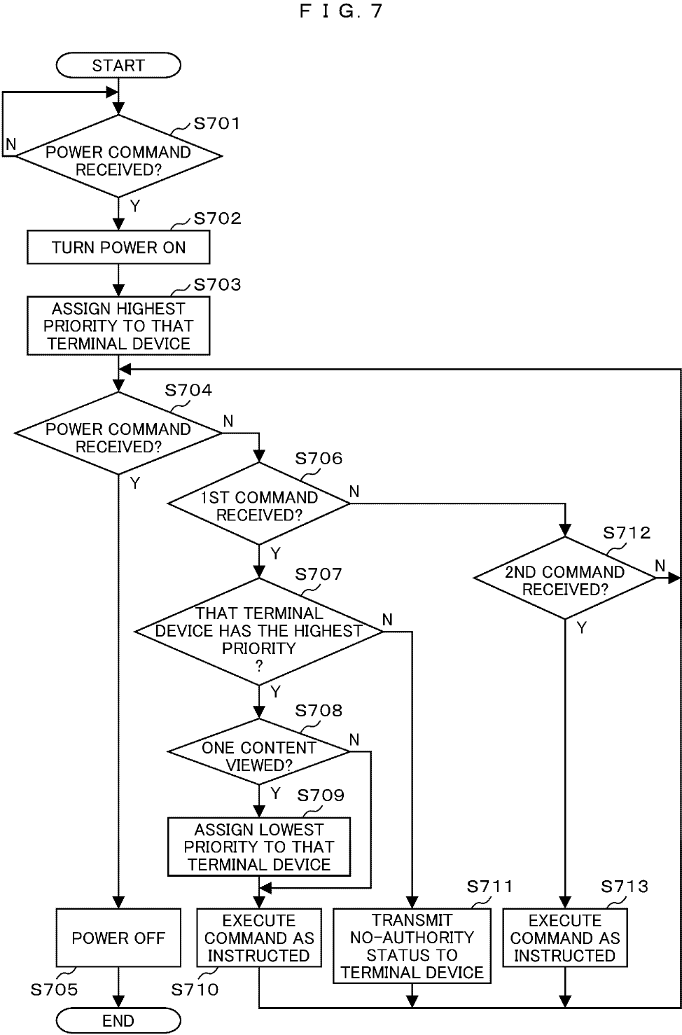

FIG. 7 is a flowchart of an operation of the video display apparatus 3 of the present embodiment.

In Step S701, the video display apparatus 3 waits for reception of the power command. When having received the power command, the video display apparatus 3 turns its power on (Step S702). Then the video display apparatus 3 sets the priority of the terminal device 1 transmitting the power command to the highest priority in Step S703. Please note that it is assumed that the terminal device 1a has transmitted to the power command.

Then, in Step S704, the video display apparatus 3 confirms whether or not it has received the power command again. In a case where the video display apparatus 3 has received the power command, it turns the power off (Step S705). In a case where the video display apparatus 3 has not received the power command, it confirms whether or not it has received the first command in Step S706. The first command is a setting command to change a channel or an input, as in the first embodiment. In a case of having received the first command, the video display apparatus 3 confirms whether or not the priority of the terminal device 1 transmitting the command is the highest (Step S707). When the priority is the highest, the video display apparatus 3 confirms whether or not one content has been viewed, that is whether or not reproduction of one unit of video content has been finished (Step S708). When the content has been viewed, the video display apparatus 3 changes the priority of that terminal device 1 to the lowest priority in Step S709. In this case, the priorities of the terminal devices 1 having the second highest and the subsequent priorities are moved up. The change of priorities is achieved by storing new priorities of the respective terminal devices 1 in the memory unit 36 of the video display apparatus 3.

Then, in Step S710, the video display apparatus 3 executes the command as instructed, and then repeats Step S704 and the subsequent steps.

For example, in a case where the user has viewed one content by using the terminal device 1a, the priority of the terminal device 1a is set to the lowest. Then, when the first command has been transmitted from the terminal device 1b, that command is executed as instructed because the priority of the terminal device 1b is the highest. At this time, the terminal device 1a does not have an authority of executing the first command. However, even when the priority of the terminal device 1a is changed to the lowest, the terminal device 1a is handled as having the highest priority and is permitted to execute the first command before transmission of the first command from another terminal device, e.g., the terminal device 1b, because there is no other terminal device having a higher priority than the terminal device 1a.

In Step S707, in a case where the priority of that terminal device 1 is not the highest, the video display apparatus 3 transmits to that terminal device 1 status information indicating no authority of execution (Step S711). For example, in a case where the terminal device 1b has transmitted the first command, this status information is transmitted to the terminal device 1b and the terminal device 1b displays an indication of no authority of execution of this command on the display unit 22.

In Step S706, in a case where the video display apparatus 3 has not received the first command, the video display apparatus 3 confirms whether or not it has received the second command (Step S712). The second command is the setting command other than the first command, as in the first embodiment.

In a case where having received the second command, the video display apparatus 3 executes the command as instructed (Step S713) and then repeats Step S704 and the subsequent steps. In a case where having not received the second command in Step S712, the video display apparatus 3 repeats Step S704 and the subsequent steps.

In this manner, for execution of the first command, the highest priority is first given to the terminal device 1a which has turned the video display apparatus 3 on, and then the priority of the terminal device 1a is changed to the lowest after viewing of one content, thereby the authority of execution of the first command is moved to the terminal device 1b. Execution of the second command can be performed from both the terminal devices 1a and 1b.

With the above-described structure, the same effects as those in the first embodiment can be obtained in the second embodiment of the present invention.

Moreover, the authority of execution of the first command in the video display apparatus 3 is first given to the terminal device 1 which has turned that video display apparatus 3 on, and is moved to another terminal device 1 every time one content has been viewed. Therefore, without borrowing and lending the terminal device 1 to be used between users, the execution authority can be given to all the terminal devices 1 in turn. For example, in a case where the first command is the setting command to instruct the video display apparatus 3 to change a channel, the terminal device 1 instructing that video display apparatus 3 to turn the power on can select the channel first and can view at least one content.

A trigger for moving the authority of execution of the first command is not limited to a finish of reproduction of one unit of video content, but may be a finish of reproduction of a plurality of units of video content. Moreover, the number of the viewed video contents, that is used as the trigger for changing the authority of execution of the first command, may be changeable based on the user's operation.

### Example 3

Next, a third embodiment of the present invention is described. The structure, effects and the like in the present embodiment are also the same as those in the first embodiment unless otherwise specifically mentioned. Therefore, differences between the present embodiment and the first embodiment are mainly described in the following description.

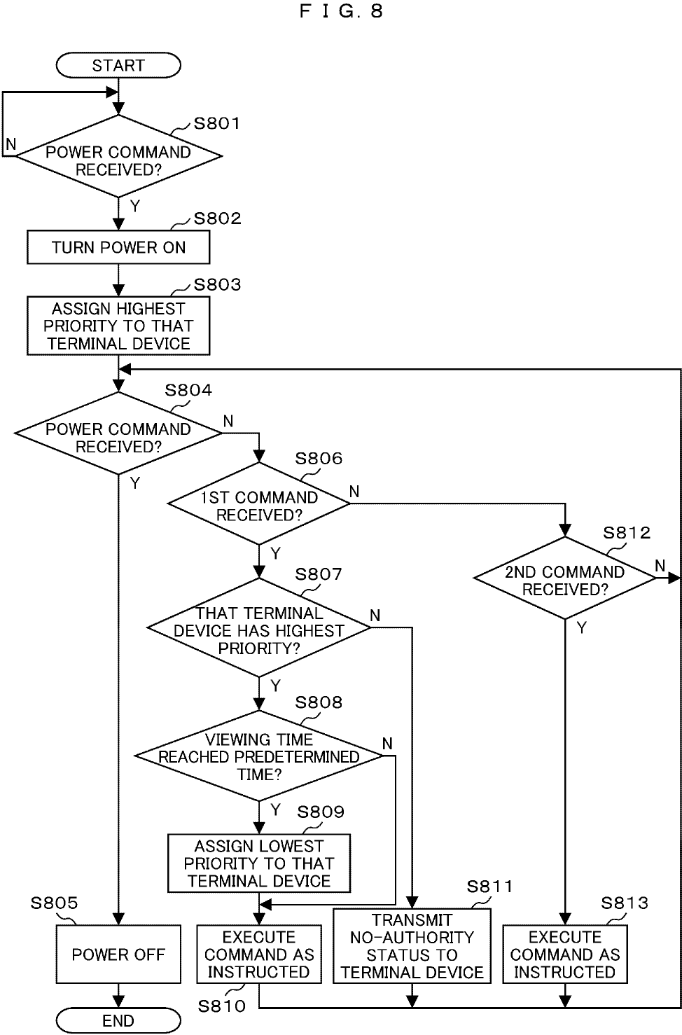

FIG. 8 is a flowchart showing an operation of the video display apparatus 3 of the present embodiment.

Steps S801 to S806 are the same as Steps S701 to S706 in FIG. 7 and therefore the description thereof is omitted.

In Step S807, in a case where the priority of that terminal device 1 is the highest, the video display apparatus 3 confirms whether or not a video-content viewing time of the user has reached a predetermined time (Step S808). The video display apparatus 3 changes the priority of that terminal device 1 to the lowest priority in Step S809 if the viewing time has reached the predetermined time, but does not change the priority if the viewing time has not reached.

For example, in a case where the user has viewed the video content for a predetermined time by using the terminal device 1a, the priority of the terminal device 1a is changed to the lowest priority. Then, when the first command has been transmitted from the terminal device 1b, execution of that command is allowed because the priority of the terminal device 1b is the highest. At this time, the terminal device 1a loses the authority of execution of the first command. However, even when the priority of the terminal device 1a has been changed to the lowest priority, the terminal device 1a is handled as having the highest priority and is allowed to execute the first command before transmission of the channel change command from another terminal device, e.g., the terminal device 1b, because there is no apparatus having higher priority than the terminal device 1a.

As for Steps S811 to S813, the description is omitted because these steps are the same as Steps S711 to S713 in FIG. 7.

As described above, for execution of the first command, the highest priority is given to the terminal device 1a turning the video display apparatus 3 on first, and then the priority of the terminal device 1a is changed to the lowest priority when the viewing time of the user has reached a predetermined time, thereby the authority of execution of the first command is moved to the terminal device 1b. Execution of the second command can be performed from both the terminal devices 1a and 1b.

With the above-described structure, the same effects as those in the first embodiment can be obtained in the third embodiment of the present invention.

Moreover, the authority of execution of the first command in the video display apparatus 3 is first given to the terminal device 1 which has turned that video display apparatus 3 on, and is moved to another terminal device 1 every time the viewing time of the user reaches a predetermined time. Therefore, the execution authority can be given to all the terminal devices 1 in turn. For example, in a case where the first command is the setting command to instruct the video display apparatus 3 to change a channel, the terminal device 1 instructing that video display apparatus 3 to turn the power on can select the channel first and can perform viewing for at least a predetermined time.

The video-content viewing time as a trigger for moving the authority of execution of the first command may be changeable based on the user's operation.

### Example 4

Next, a fourth embodiment of the present invention is described. The structure, effects and the like in the present embodiment are also the same as those in the first embodiment unless otherwise specifically mentioned. Therefore, differences between the present embodiment and the first embodiment are mainly described in the following description.

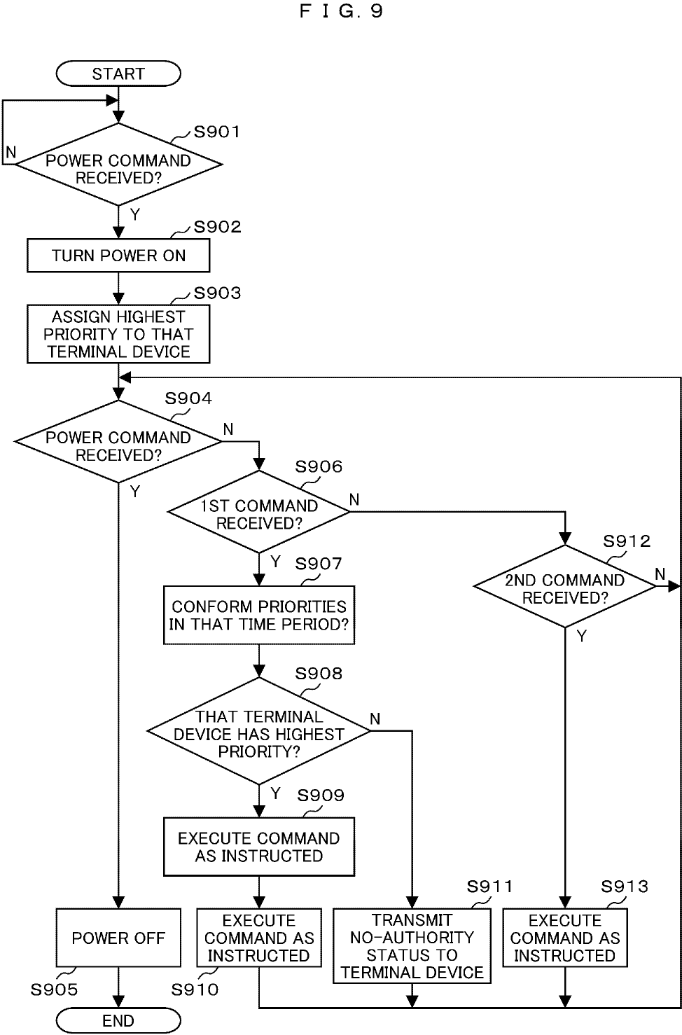

FIG. 9 is a flowchart showing an operation of the video display apparatus 3 of the present embodiment.

For Steps S901 to S905, the description is omitted because these steps are the same as Steps S701 to S705 in FIG. 7. Also in the present embodiment, it is assumed that the terminal device 1a has transmitted the power command.

In Step S906, the video display apparatus 3 confirms whether or not it has received the first command. In a case where the video display apparatus 3 has received the first command, the video display apparatus 3 confirms the priorities in the corresponding time slot (Step S907) and confirms whether or not the priority of the terminal device 1 transmitting that command is the highest (Step S908). In a case where the priority is the highest, the video display apparatus 3 executes that command as instructed.

In Step S908, in a case where the priority is not the highest, the video display apparatus 3 transmits status information indicating no authority of execution to that terminal device 1 (Step S911). For example, in a case where the terminal device 1b has transmitted the first command, this status information is transmitted to the terminal device 1b, and the terminal device 1b displays an indication of no authority of execution of that command on the display unit 22.

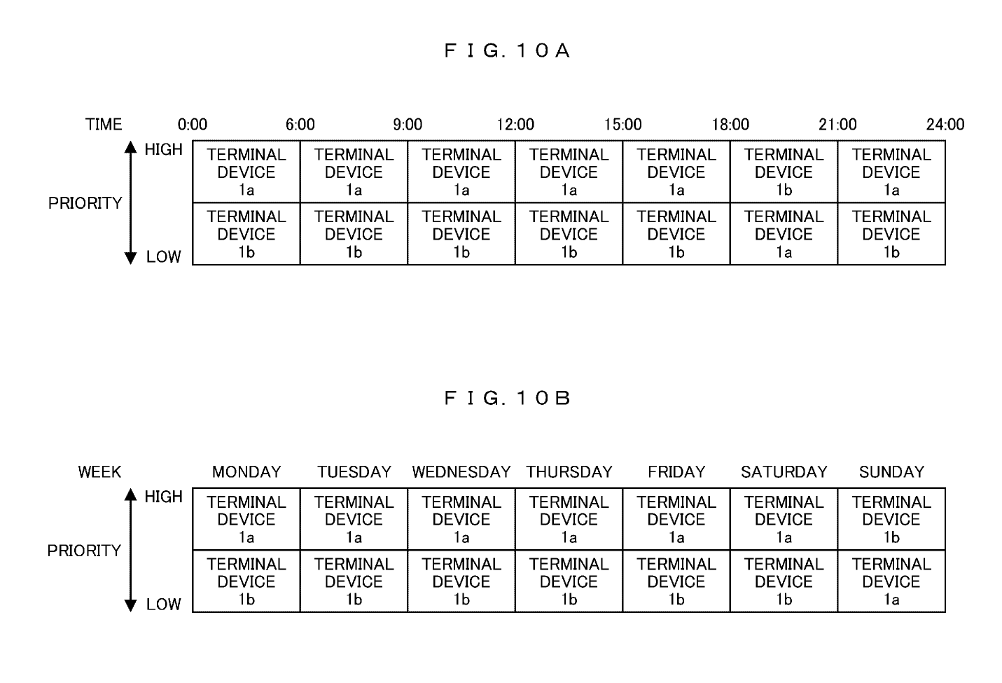

The priorities of the respective terminal devices 1 can be changed depending on time slots and days of a week. For example, it is possible to set the priority of the terminal device 1b to be higher than that of the terminal device 1a only in a time slot from 18:00 to 21:00 (see FIG. 10A) or only on Sundays (see FIG. 10B).

To the contrary, the priorities of the respective terminal devices 1 can be fixed. Moreover, those can be combined with each other.

For Steps S912 to S913, the description is omitted because these steps are the same as Steps S712 to S713 in FIG. 7.

In this manner, it is possible to give the highest priority to the terminal device 1 turning the video display apparatus 3 on first and to change the priorities between that terminal device 1 and another terminal device based on time slots or days of a week.

With the above-described structure, the same effects as those in the first embodiment can be obtained in the fourth embodiment of the present invention.

Moreover, the authority of execution of the first command in the video display apparatus 3 is first given to the terminal device 1 which has turned the video display apparatus 3 on, and is moved to another terminal device 1 in accordance with a time slot or a day of a week. Therefore, the execution authority can be given to all the terminal devices 1 in turn. For example, in a case where the first command is the setting command to instruct the video display apparatus 3 to change a channel, the terminal device 1 instructing that video display apparatus 3 to turn the power on can select the channel first, and the channel change authority can be moved to another terminal device based on the time slots and days of the week.

### Example 5

Next, a fifth embodiment of the present invention is described. The structure, effects and the like in the present embodiment are also the same as those in the first embodiment unless otherwise specifically mentioned. Therefore, differences between the present embodiment and the first embodiment are mainly described in the following description.

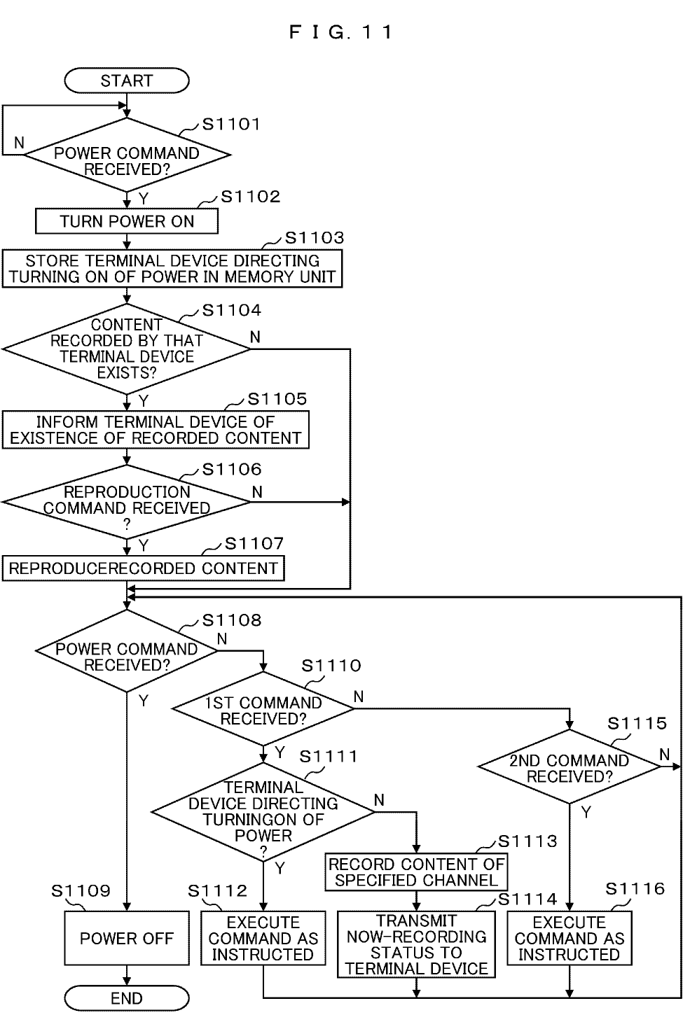

FIG. 11 is a flowchart showing an operation of the video display apparatus 3 of the present embodiment.

For Steps S1101 to S1103, the description is omitted because these steps are the same as Steps S601 to S603 in FIG. 6.

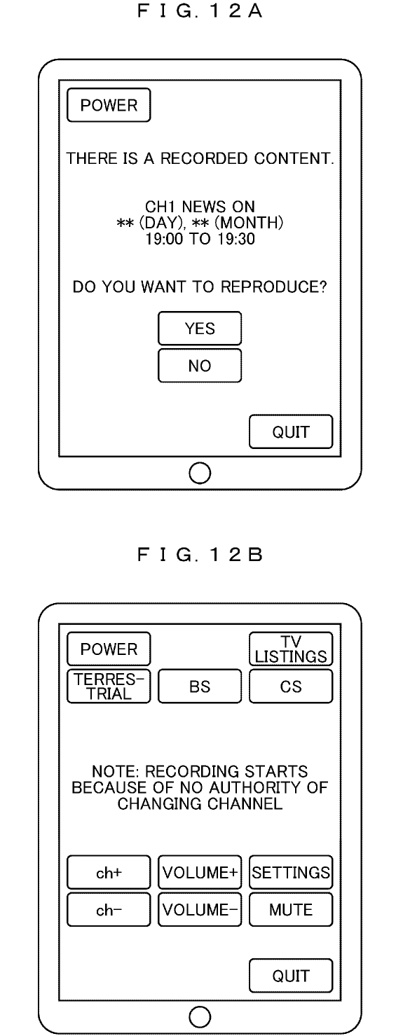

In Step S1104, in a case where there is a video content recorded in relation to the operation of that terminal device 1 (hereinafter referred to as a “recorded content”), the video display apparatus 3 informs that terminal device 1 of the existence of the recorded content. The recorded content will be described later. FIG. 12A shows an exemplary display on the screen of the terminal device 1 at that time.

Next, in Step S1107, when having received a reproduction command from the terminal device 1, the video display apparatus 3 reproduces the recorded content. The reproduction command is a command to reproduce the recorded content, and is a concept included in or similar to the setting command.

For Steps S1108 to S1110, the description is omitted because these steps are the same as Steps S604 to S606 in FIG. 6.

In Step S111, in a case where the received first command has been transmitted from the terminal device 1 turning the power on, the video display apparatus 3 executes the command as instructed (Step S112) and thereafter repeats Step S1108 and subsequent steps.

In a case where the received first command is not a command from the terminal device 1 turning the power on, the video display apparatus 3 records a video content on the instructed channel. The recorded content is stored in the memory unit 36 in FIG. 3, for example. FIG. 12B shows an exemplary display on the screen of the terminal device 1 at that time.

Then the video display apparatus 3 transmits status information indicating that recording has been started to the corresponding terminal device 1 in Step S1114. For example, in a case where the terminal device 1a has turned the video display apparatus 3 on and the terminal device 1b has transmitted the first command, this status information is transmitted to the terminal device 1b and the terminal device 1b displays an indication of no authority of channel change and an indication of recording start on the display unit 22.

For Steps S1115 to S1116, the description is omitted because these steps are the same as Steps S610 to S611 in FIG. 6.

Thus, execution of the first command in the video display apparatus 3 is possible only via the terminal device 1a turning the video display apparatus 3 on. In a case where the terminal device 1b has transmitted the first command, the video display apparatus 3 records the corresponding content. Then, that content can be reproduced when the terminal device 1b turns the video display apparatus 3 on.

Recording of the content in Step S1113 may be performed only in a case where a recording mode is set in advance. That is, the recording mode is set in advance in a case where the content is desired to be recorded, but is not set in a case where the content is not desired to be recorded.

With the above-described structure, the same effects as those in the first embodiment can be obtained in the fifth embodiment of the present invention.

Moreover, the authority of execution of the first command in the video display apparatus 3 is given to the terminal device 1 which has turned the video display apparatus 3 on, and in a case where the first command has been transmitted from another terminal device 1, the content is recorded. For example, in a case where the first command is the setting command to change a channel, the terminal device 1 turning the video display apparatus 3 on can select the channel, and the content on the channel selected by the other terminal device 1 can be recorded and viewed later although it cannot be viewed immediately.

### Example 6

Next, a sixth embodiment of the present invention is described. The structure, effects and the like in the present embodiment are also the same as those in the first embodiment unless otherwise specifically mentioned. Therefore, differences between the present embodiment and the first embodiment are mainly described in the following description.

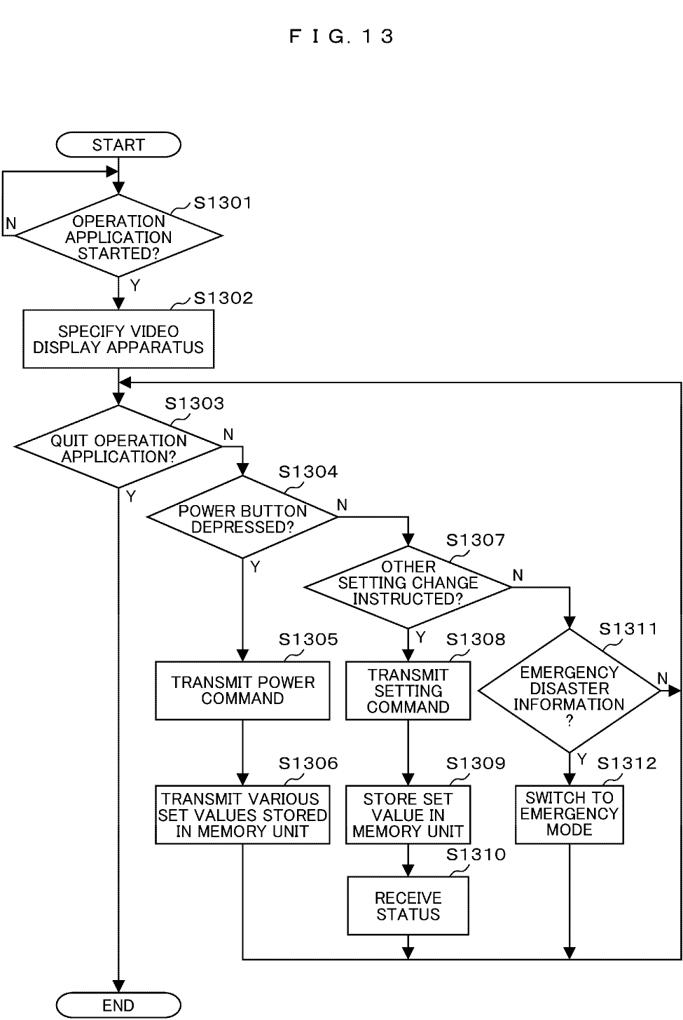

FIG. 13 is a flowchart showing an operation of the terminal device 1 of the present embodiment.

For Steps S1301 to S1310, the description is omitted because these steps are the same as Steps S401 to S410 in FIG. 4.

In Step S1311, when having received emergency disaster information, the terminal device 1 switches from a normal mode to an emergency mode. The emergency disaster information is information telling an emergency such as occurrence of a disaster. For example, an earthquake early warning is applied to that information.

The terminal device 1 in the emergency mode displays the content of the emergency disaster information on its display screen and also transmits a command and an emergency code which is in place of the identification code unique to the terminal device 1 or is added to the identification code, to the video display apparatus 3.

Thus, the terminal device 1 which has received the emergency disaster information is switched to the emergency mode, and adds the emergency code when operating the video display apparatus 3, thereby switching the video display apparatus 3 to the emergency mode.

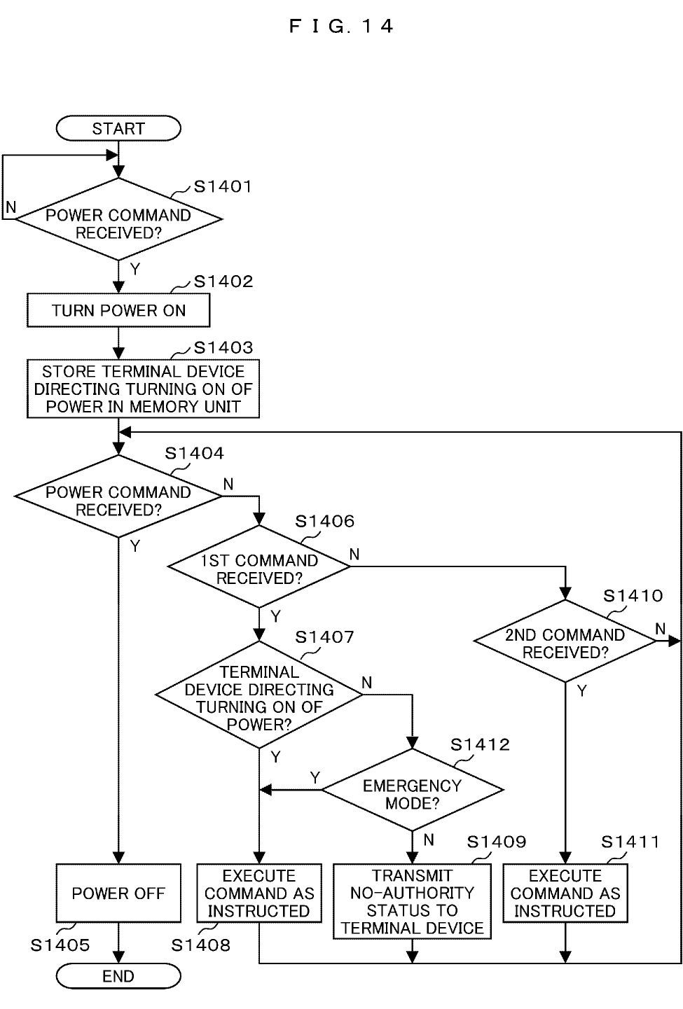

FIG. 14 is a flowchart showing an operation of the video display apparatus 3 of the sixth embodiment.

For Steps S1401 to S1411, the description is omitted because these steps are the same as Steps S601 to S611 in FIG. 6.

In Step S1412, the video display apparatus 3 confirms whether or not it has received the emergency code. In a case of having received the emergency code, the video display apparatus 3 switches to the emergency mode and executes the command as instructed (Step S1408), and thereafter repeats Step S1404 and subsequent steps.

In this manner, execution of the first command via all the terminal devices 1 is possible in the emergency mode.

As the emergency disaster information, other than the earthquake early warning, an emergency thunder warning, an emergency fire flash report, an emergency tsunami warning, an emergency typhoon warning, an emergency warning of heavy rain, an emergency flood flash report, an emergency eruption flash report, and the like may be applied. Moreover, in the emergency mode, the video display apparatus 3 itself may receive the earthquake early warning.

With the aforementioned structure, the same effects as those in the first embodiment can be obtained in the sixth embodiment of the present invention.

Moreover, when having received the emergency disaster information, execution of the first command is possible via all the terminal devices 1. For example, in a case where the first command is the setting command to change a channel, when the emergency disaster information has been received, channel selection is possible via all the terminal devices 1.

The above-described embodiments are described in detail for easy understanding of the present invention, but the present invention is not necessarily limited to an example which includes all the described structures. Moreover, a portion of the structure of one of the embodiments can be replaced with the structure of another embodiment. Also, to the configuration of one embodiment, the configuration of another embodiment can be added. Furthermore, for a portion of the structure of each embodiment, addition of another structure, deletion, and replacement can be performed.

In addition, each of the above-described structures, functions, processors, processing units and the like may be partly or entirely implemented by hardware, for example, by being designed by an integrated circuit. Moreover, each of the above-descried structures, functions, and the like may be implemented by software by interpretation and execution of a program for achieving that function by a processor. Information such as a program for achieving each function, a table, a file, and the like can be stored in a recording apparatus such as a memory, a hard disk, and a SSD (Solid State Drive) or a recording medium such as an IC card and an SD card.

Control lines and information lines that are considered as being necessary for the description are shown. Not all the control lines and the information lines of a product are shown. It may be considered that actually almost all the structures are mutually connected to each other.

### REFERENCE SINGS LIST

1: Terminal device,
3: Video display apparatus,
4: Base station,
5: Broadcast station,
6: Wireless router,
7: Network,
21: Wireless communication unit,
22: Display unit,
23: Operation unit,
24: Command transmitting unit,
25: Status receiving unit,
26: Memory unit,
30: Control unit,
31: TV signal receiving unit,
32: Display unit,
33: Audio output unit,
34: Command receiving unit,
35: Status transmitting unit,
36: Memory unit,
37: LAN transceiver unit.

1. A video display apparatus comprising:
a display unit configured to display a video content;
a receiving unit configured to receive a command transmitted from a terminal device; and
a control unit configured to execute processing in accordance with a command received by the receiving unit, wherein
the control unit executes, when a first command from a specific terminal device is received, processing in accordance with the first command, while not executing the processing in accordance with the first command when the first command from another terminal device has been received, and
the control unit executes, when a second command from the specific terminal device is received or the second command from the other terminal device is received, processing in accordance with the second command.

2. The video display apparatus according to claim 1, wherein
the control unit executes the processing in accordance with the first command, when the first command from the specific terminal device is received, a predetermined number of video contents are displayed, and thereafter the first command from the other terminal device is received.

3. The video display apparatus according to claim 1, wherein
the control unit executes the processing in accordance with the first command, when the first command from the other terminal device is received after the first command from the specific terminal device is received and a video content is displayed for a predetermined time period.

4. The video display apparatus according to claim 1, further comprising a memory unit configured to store priorities of the specific terminal device and the other terminal device with respect to each other for each time or each day of a week, wherein
the control unit determines whether or not to execute the processing in accordance with the first command from the specific terminal device based on the priorities stored in the memory unit.

5. The video display apparatus according to claim 1, wherein,
when the first command from the other terminal device is received, the control unit records a predetermined video content in a recording medium.

6. The video display apparatus according to claim 5, wherein,
when the first command from the other terminal device is received while a recording mode is set, the control unit records the predetermined video content in the recording medium.

7. The video display apparatus according to claim 1, wherein,
when the first command from the other terminal device is received in a normal mode, the control unit does not execute the processing in accordance with the first command, and
when the first command from the other terminal device is received in an emergency mode, the control unit executes the processing in accordance with the first command.

8. The video display apparatus according to claim 7, wherein
the video display apparatus is switched to the emergency mode in a case where information on an emergent disaster is received.

9. The video display apparatus according to claim 1, wherein
the specific terminal device is a terminal device which has transmitted a command related to a power supply.

10. The video display apparatus according to claim 1, further comprising a specifying unit configured to specify whether a specific command is the first command or the second command based on a user's operation.

11. The video display apparatus according to claim 1, wherein the first command is a command related to a change of a channel.

12. The video display apparatus according to claim 1, wherein the second command is a command related to a reservation for viewing or a reservation for recording.

13. A terminal device having a remote control function for a video display apparatus, comprising:
a transmitting unit configured to transmit a command related to a setting of the video display apparatus; and
a memory unit configured to store a content of the command transmitted from the transmitting unit, wherein
the transmitting unit transmits the content of the command stored in the memory unit when transmitting a power command to the video display apparatus.

14. The terminal device according to claim 13, further comprising a receiving unit configured to receive information related to an emergent disaster, wherein
the transmitting unit transmits a predetermined emergency code to the video display apparatus when the information related to an emergent disaster has been received by the receiving unit.
